(19) United States
(12) Patent Application Publication
(10) Pub. No.: US 2016/0039477 A1
(43) Pub. Date: Feb. 11, 2016

(54) ZERO AERODYNAMIC DRAG VEHICLES

(71) Applicant: Othman Bin Ahmad, Kota Kinabalu (MY)

(72) Inventor: Othman Bin Ahmad, Kota Kinabalu (MY)

(21) Appl. No.: 14/833,144

(22) Filed: Aug. 24, 2015

(51) Int. Cl. B62D 35/00; B64C 1/00; B60K 6/40; B60K 8/00; B64D 27/20

(52) U.S. Cl. CPC B62D 35/00; B60K 8/00; B64D 27/20; B60K 6/40; B64C 1/0009

(57) ABSTRACT

A vehicle for transporting people as well as goods that moves with minimal aerodynamic drag loss because the energy in the aerodynamic drag is transferred to the propulsive thermal engine. The high dynamic air pressure in front of the vehicle (1) as a result of the vehicle (1) moving faster than the surrounding air is sucked by the air compressor (10) through the air intake (5) and variable sized air intake nozzles (2)(3). The low dynamic air pressure at the back of the vehicle (1) as a result of the vehicle (1) leaving behind the surrounding air, is filled back by the exhaust gas coming out through the exhaust nozzles (6). All the nozzles (2)(3)(6) are optionally adjustable in order to optimise the sucking and filling capacities of the thermal engine. The present invention also applies to flying vehicles, road vehicles as well as but not limited to underwater vehicles.

### 1. FIELD OF THE INVENTION

The present invention relates to a vehicle design to reduce loss due to air drag.

### 2. BACKGROUND OF THE INVENTION

It is widely understood that when vehicles move, they induce aerodynamic drag. This drag causes a loss in power in moving the vehicle. This power loss can be higher than 50% of the total propulsive power at high speeds. This drag can be viewed as being caused by high pressure region in front of the vehicle which creates force to push the vehicle against the forward force created by the propulsion of the vehicle and a vacuum at the back of the vehicle that pulls the vehicle backward.

With such huge energy losses, current arts solve the problem by designing vehicles with aerodynamic shapes. Sport cars need to be small because they are designed to travel fast. To the extreme are rocket shaped land speed record breakers. For medium speed, tear drop shapes can be used but not successful commercially. A.L.F.A., which later became Alfa Romeo®, patented ‘air-resisting train’ in an 1865 patent. It formed the basis for the 1914 A.L.F.A. 40/60HP Aerodinamica Prototype, created for Count Marco Ricotti by the Castagna Coachbuilding firm as reported by a Daily Mail reporter on the 19^{th} of April 2012, in an online publication called MailOnline®. That prototype uses a tear drop design.

Another prior art technique is by using turbo or super chargers to boost the air intake into internal combustion engines so that more power can be created by similar sized engines. The pressure due to drag is insufficient especially at low speed to provide such additional power and therefore air scoops need to be provided by air blowers blowing air into the internal combustion engine.

Yet another prior art technique is by using spoilers or ground effect skirts to increase the downward force for vehicles in order to improve handling during turning. It does not improve the energy efficiency of the vehicle.

Air scoops are used by prior arts to utilise the aerodynamic drag to cool engine and air conditioning radiators.

The inventor had disclosed some ideas on using aerodynamic drag for other purposes but it was not fully disclosed in the electronic journal, EJUM, Engineering e-Transaction, Volume 6, No 2, 2011.

U.S.A. patent no U.S. Pat. No. 7,165,804 B2, 2007, issued to Khosrow Shahbazi, shows a technique that uses the high pressure region in front of the vehicle and the low pressure region at the back of the vehicle to reduce aerodynamic drag, simply by connecting the high pressure region to the lower pressure region.

### 3. TECHNICAL PROBLEM

The prior art solves the aerodynamic drag problem by designing gently sloping shapes to minimise drag. However, the aerodynamic shapes make the vehicles smaller in cross sectional area but very long. These aerodynamic shapes are not ideal for carrying human passengers or travelling on roads. Passengers find it awkward to move into sports cars which are too small because of their need for aerodynamic shapes. We also do not see any rocket shaped vehicles on roads because they will be awkward to manoeuvre on roads because they have to be long but thin so passengers cannot sit side by side. Even tear drop shapes are not successful commercially.

Other uses of aerodynamic drag to increase downward force are only useful when braking and turning. Air scoops also use only a little of the total air drag which is wasted for cooling purposes. The cooling radiator should be placed at the low pressure region of the vehicle to contribute to reducing aerodynamic drag by expanding the air that is used to cool the radiators. Connecting high pressure region to low pressure region can only reduce but not eliminate aerodynamic drag.

### 4. TECHNICAL SOLUTION

The solution is therefore not to reduce aerodynamic drag too much that cargo space is compromised. We must live with some aerodynamic drag which causes some power loss. Another alternative that is exploited by the present invention is to cancel the effects that cause aerodynamic drag, namely the high-pressure region in front of the vehicle and the vacuum at the back of the vehicle. Then we have a vehicle that has zero aerodynamic drag.

If Pₚ is the power that drives the vehicle forward, coming from the engine,
P_{f} is the power of the high pressure in front of the vehicle pushing it backward,
P_{b} is the power of the vacuum at the back of the vehicle pushing it backward.

Since we are only interested to study the effect of aerodynamic drags, we ignore the effect of skin effects for the moment as well as friction and other losses.

Based on the first law of thermodynamics or conservation of energy:

Pₚ−P_{f}−P_{b}=0

Where P_{f}+P_{b} is the total aerodynamic drag.

When we add a vacuum pump in front, there will be an effective power of Pᵥ that can cancel the high-pressure build-up of the air in front of the moving car. When we add a compressor at the back, we can cancel the effect of the vacuum created at the back of the moving car, with an effective power of P_{c}.

Pₚ−P_{f}−P_{b}+Pᵥ+P_{c}=0

Pₚ=P_{f}−Pᵥ+P_{b}−P_{c}

If P_{f}=Pᵥ, P_{f}−Pᵥ=0

If P_{b}=P_{c}, P_{b}−P_{c}=0

Therefore Pₚ=0. This means that there is no need for any propulsive force to drive the car against the force created by air drag. In other words, we have achieved zero aerodynamic drag.

In the present invention, the air intake of a thermal engine is configured as a vacuum pump. The exhaust outlet of a thermal engine is configured as a compressor. In this way, the present invention uses the power normally lost to aerodynamic drag, to increase the efficiency of thermal engines instead of just to increase downward force. The aerodynamic vacuum effect can be fully utilised to increase the power of thermal engines especially at high speed by forcefully sucking their exhaust gases.

The higher the speed of the vehicle, the larger the aerodynamic drag losses and therefore the larger is the force due to vacuum effects. To minimise losses, this vacuum must be filled with extra gas. Instead of using the surrounding air to fill in the vacuum by tapering the vehicle body, we can leave the body as it is but fill it with gas from the exhaust of the thermal engine and air that is heated by the cooling radiators from both engine and air conditioning. The engines can be thermal engines such as but not limited to jet engines and internal combustion engines but the use of the compressors and vacuum pumps to remove aerodynamic drag techniques can be applied to electric motors as well. This is done by diverting some of the power meant for the motor, to the compressors and vacuum pumps.

The exhaust of the jet engine or internal combustion engine should be diverted to the central region at the back of the vehicle, where the vacuum effect is strongest. Prior arts place these exhausts at the sides of the vehicles in order to maximise space.

The high pressure region can be used to feed air into the thermal or other types of engines that can suck the air from the high pressure frontal area of the vehicle. If the sucking power of the engines is not sufficient, there will be more aerodynamic drag. Variable size intake and exhaust nozzles are required to reduce the aerodynamic drag in circumstances where the sucking power of the engines is not sufficient, by using a gently sloping surface.

To reduce drag due to skin effect, the frontal area of the nozzles can be increased to envelope the whole body with vacuum created behind the nozzles, at the travelling speed.

### 5. ADVANTAGEOUS EFFECTS

The vacuum created by aerodynamic drag can suck the pistons of the internal combustion engines together with the burnt gases at the exhaust outlet. Another way of looking at it is to see the exhaust and cooling air fill the vacuum created by the aerodynamic drag, and thus reducing the aerodynamic drag.

The high pressure air at the intake nozzle pushes the pistons or rotors, increasing the power of the engines. The power lost due to aerodynamic drag is transferred to the engines and there is no limit to how much of this power contributed by aerodynamic drag, can be transferred to the engine, unlike the cooling, ground and other effects of air. Some costs are required to divert the exhaust gas outlets to the back of the vehicle but a person skilled in the art should be able to minimise the cost compared to the alternative of reducing the vacuum effect by using gently sloping body shapes.

### 6. BRIEF DESCRIPTION OF THE DRAWINGS

The invention is best described by using the following:

FIG. 1A-1C showing the embodiment as a turbo jet flying vehicle, in which FIG. 1A shows the front view, FIG. 1B shows the side view and FIG. 1C shows the top view of the adjustable air intake nozzle.

FIG. 2A-2B showing an embodiment using turbo prop with wheels,in which FIG. 2A shows the front view, and FIG. 2B shows the side view.

FIG. 3A-3B showing an embodiment using an internal combustion engine, in which FIG. 3A shows the front view, and FIG. 3B shows the side view.

FIG. 4A-4B showing an example where all nozzles are closed to reduce aerodynamic drag, in which FIG. 4A shows the front view, and FIG. 4B shows the side view.

FIG. 5 showing an embodiment that reduces the aerodynamic drag of a standard car.

FIG. 6A-6B showing an embodiment for a vehicle that is powered by an electric motor, in which FIG. 6A shows the front view, and FIG. 6B shows the side view.

FIG. 7A-B shows an embodiment in environments where thermal engines and wheels are not suitable such as underwater, in which FIG. 7A shows the top view, and FIG. 7B shows the side view.

### 7. BEST MODE

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

The configuration of the present invention will be apparent from the description of embodiments with reference to the accompanying drawings.

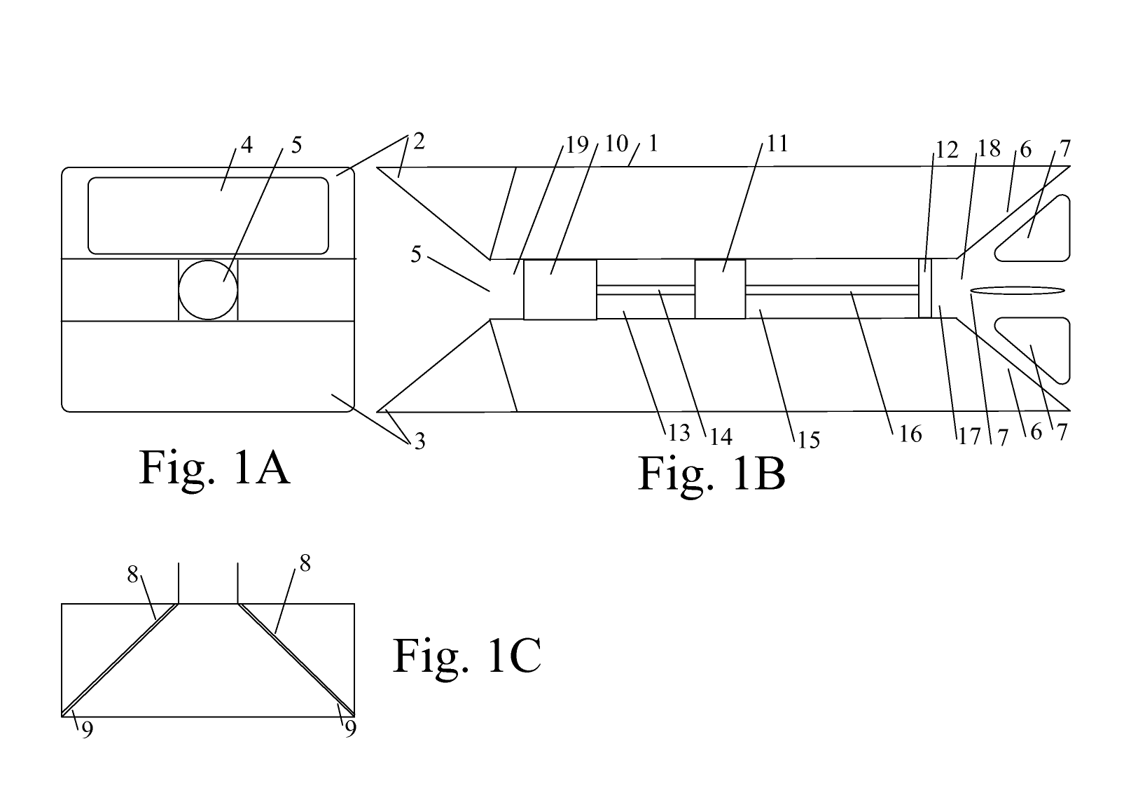

As shown in FIG. 1A the front view and FIG. 1B, the side view, the best embodiment of the present invention is a vehicle (1) which includes an adjustable upper air intake nozzle (2), a lower intake nozzle (3), a transparent viewing port (4) which should occupy most of the surface area of the upper air intake nozzle (2) so that visibility is not affected as the nozzle is adjusted, air intake (5), exhaust nozzle (6), vectored thrust vanes (7), air compressor (10), burner (11), turbo charger (12), compression pipe (13), compression pipe shaft (14), hot gas pipe (15), hot gas shaft (16), exhaust pipe (17), exhaust outlet (18) and intake pipe (19). FIG. 1C shows the top view of the adjustable air intake nozzle showing the fixed nozzle sidewall (8) and the moveable upper moveable nozzle sidewall (9). There should be a similar moveable lower nozzle sidewall underneath the upper moveable nozzle sidewall (9). This embodiment is for a wingless flying machine for extremely high speed of more than 300 km/hr.

The air compressor (10), burner (11), turbo charger (12), compression pipe (13), compression pipe shaft (14), hot gas pipe (15), hot gas shaft (16) forms a standard turbo jet or turbo fan engine.

The air compressor (10) sucks air through the air intake (5), via the air intake nozzles (2)(3) and intake pipe (19) at a rate such that the excess air as the vehicle (1) moves forward is all sucked into the compression pipe (13) at such a rate that there is no high dynamic pressure in front of the vehicle (1). The compressed air is used to burn carefully adjusted amount of fuel in the burner (11) so that the volume of the gas is increased further by the increase in temperature and sent to the hot gas pipe (15). The heated gas then exits to the outside via the exhaust pipe (17), exhaust outlet (18) and exhaust nozzle (6) through the turbo charger (12). Some of the gas energy is captured by the turbine blades of the turbo charger (12) which turns the hot gas shaft (16) which is directly connected to the compression pipe shaft (14) to turn the turbine blades of the air compressor (10). The rate at which the exhaust gas exits the exhaust nozzle (6) must be high enough to offset the low dynamic pressure at the back as the vehicle (1) moves forward.

The size of the opening of nozzles (2), (3) and (6) must be large enough that its opening surface area with respect to the direction of travel, covers all the frontal surface area of the vehicle (1). In this way, all the aerodynamic drag energy will be captured by the vehicle (1). When the nozzles are fully open, the vehicle (1) presents a cigar shaped vehicle that has a coefficient of drag of around 0.82. This coefficient can be reduced further by further increasing the surface area covered by the nozzles (2)(3)(6) so that the vacuum behind the nozzle can cover all the skin of the body of the vehicle (1).

The air intake nozzles (2)(3) are sizeable by sliding the sidewalls (8)(9) and by using hinges strategically located. When the nozzles (2)(3) are closed, the aerodynamic drag of this gently sloping shape is much less than 0.82. This lower aerodynamic drag configuration is useful when the dynamic pressures in front and at the back of the vehicle (1) cannot be economically utilised by the thermal engine through the adjustment of fuel intake.

The moveable nozzle is optional because the present invention uses the aerodynamic drag energy to increase the efficiency of the thermal engine. Any excess dynamic pressure in front is used by the thermal engine to compress the air, and the low dynamic pressure at the back helps to suck the exhaust air out, reducing the amount of fuel burned by the burner (11).

To preserve the low aerodynamic drag, this vehicle is wingless but is controlled by vectored thrusts using the vectored thrust vanes (7) placed at the exhaust nozzle. When the air intake nozzles (2)(3) are fully open and the dynamic pressures in front and at the back are zero, there is no aerodynamic drag except the skin effects as air moves against the surfaces of the vehicle (1), and the slight angle of attack attitude which is necessary in order to provide lift.

An alternative embodiment is to use conventional wings, rudder, tail and ailerons just like conventional jet aeroplanes. This allows the exhaust nozzles (6) to be closed, thus allowing some reduction in the aerodynamic drag coefficient of the vehicle (1) if required.

### 8. MODE FOR INVENTION

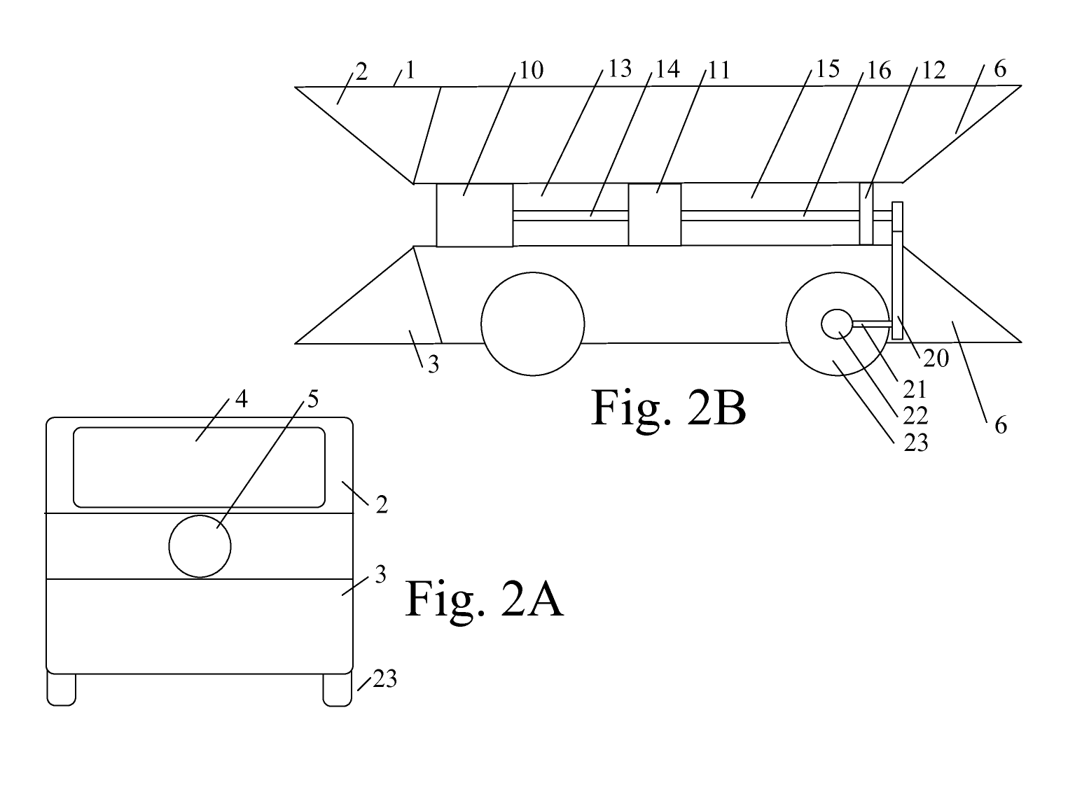

FIG. 2A-B show an embodiment with a transmission (20) to tap the rotational power of the turbo jet engine to be transferred to the differential gear (22) via the drive shaft (21) to the wheels (23) in a standard turbo prop configuration. This embodiment is suitable for a high speed land vehicle of speeds greater than 100 km/hr.

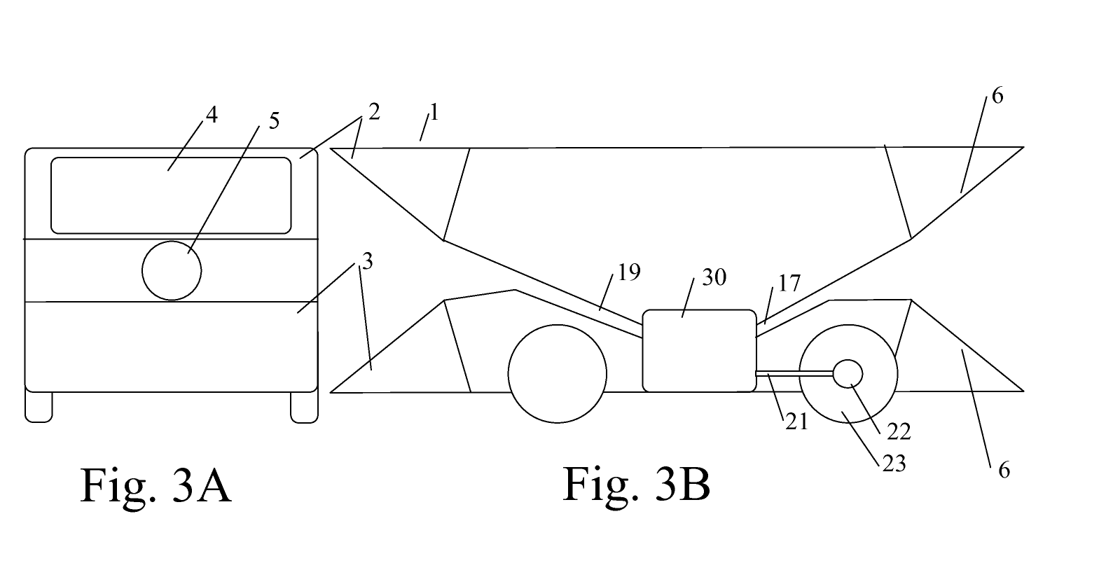

FIG. 3A-3B show an embodiment using an internal combustion engine (30) where its intake pipe (19) is connected to the air intake nozzles (2)(3) and the exhaust pipe (17) connected to the exhaust nozzles (6). The internal combustion engine drives the wheels (23) through the differential gear (22) and drive shaft (21). This embodiment is suitable for medium to low speed lorries and trains of speeds less than 100 km/hr.

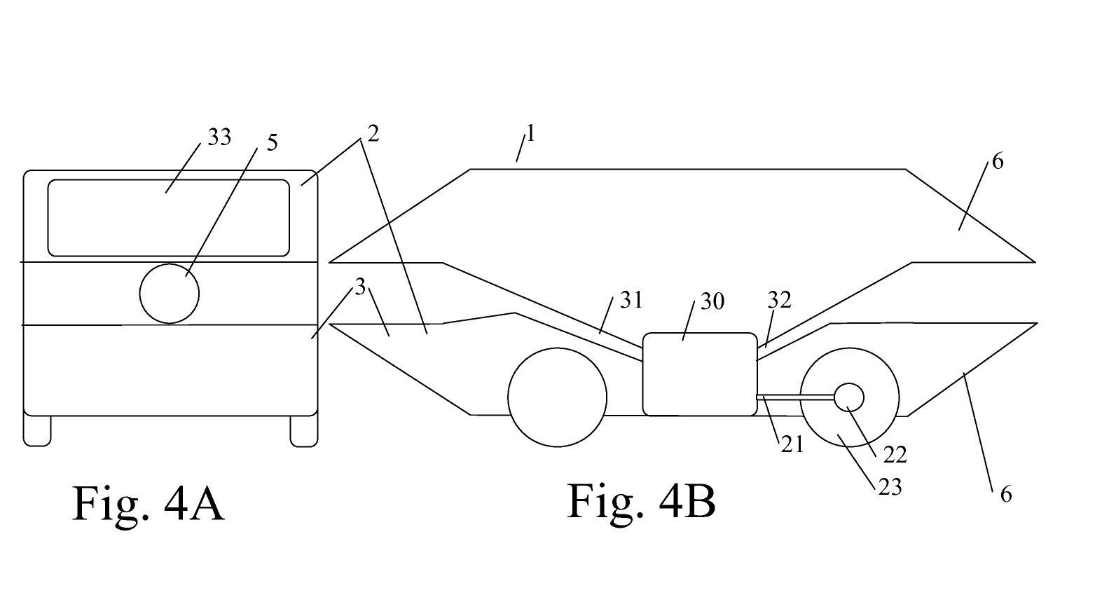

FIG. 4A-4B show an example where the nozzles (2)(3) and (6) are closed in order to reduce aerodynamic drag. An alternate viewing port (24) should appear because the alternate viewing port (24) is attached to the upper side of the intake nozzle (2). Similar sets of viewing ports may be optionally installed for the exhaust nozzles (6). The mechanism for closing the exhaust nozzles (6) is similar to the closing of the air intake nozzles (2)(3) and is shown by FIG. 1C.

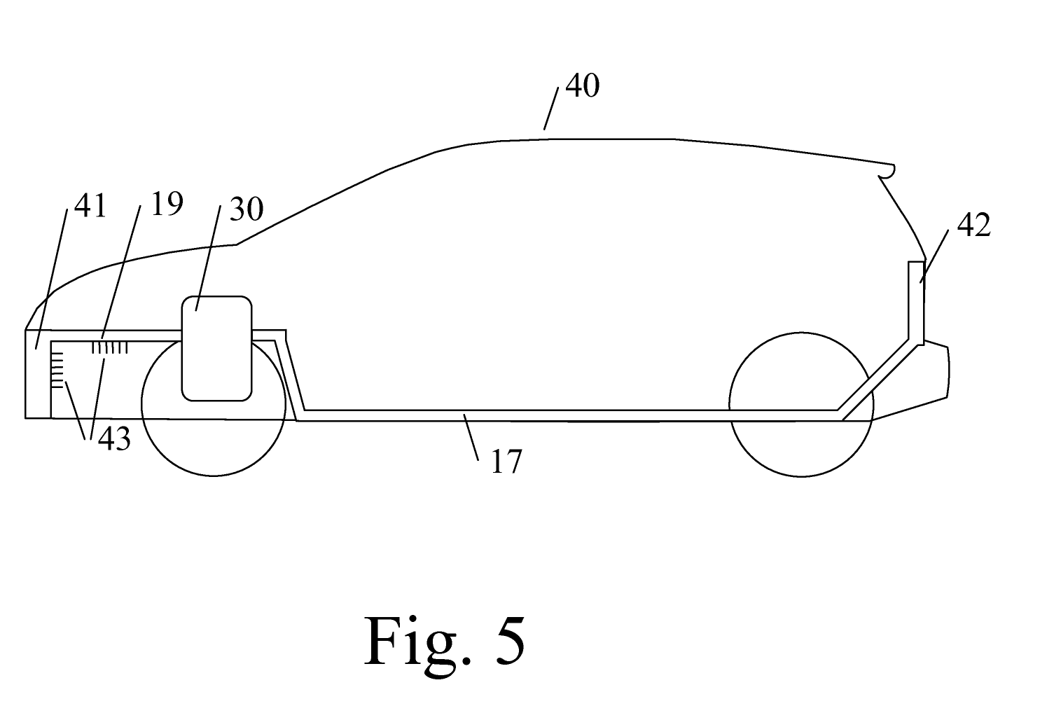

FIG. 5 shows an embodiment in a standard compact car (40) with an outline that is similar to Toyota Prius C. Prius C is less aerodynamic than the Prius partly because it is shorter. Therefore, there should be more aerodynamic drag power that can be diverted to the thermal engine. The air at the place with high dynamic pressure which is the flat and vertical portion of the front most part of the compact car (40) is captured by the air collector (41) to be sent to the internal combustion engine (30) via the intake pipe (19). The burnt gases is sent out via the exhaust pipe (17) to the exhaust diffuser (42) placed at the lowest dynamic pressure region of the car, which is commonly at the flat and vertical region at the furthest back of the compact car (40). A large air filter may be fitted inside the air collector (41) and a catalytic converter may be fitted inside the exhaust diffuser (42). It is vital that the exhaust pipe (17) and exhaust diffuser (42) are air tight and heat insulated in order to prevent the loss of hot high pressure exhaust gas as well as the drop in temperature. The air collector (41) and intake pipe (19) need also be air tight but preferably cooled by fitting fins (43) on the outer skin of the intake pipe (19) and air collector (41). The exhaust diffuser (42) may be attached to the rear door of a standard compact car (40) so a mechanism to easily attach and detach the exhaust diffuser (42) from the exhaust pipe may need to be provided.

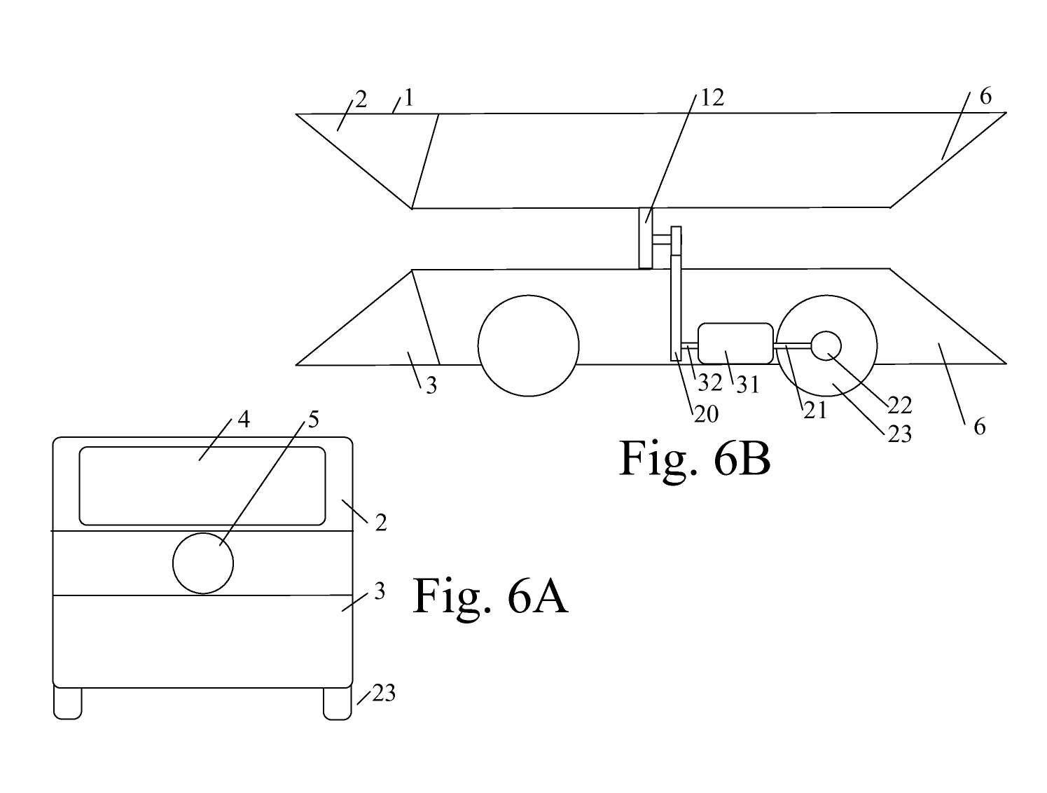

FIG. 6A-6B show an embodiment where the thermal engine components, the air compressor (10), burner (11) are replaced by an electric motor/generator (51) which is connected to the turbo charger (12) via a transmission (20) and motor shaft (52). The aerodynamic drag power, represented by air moving through pipes (13)(15)(17), is tapped by the turbo charger (12) to be fed to the electric motor/generator (51). The motor/generator (51) drives the wheels (23) via a drive shaft (21) and differential gear (22).

The transmission (20) can be set to neutral or its clutch disengaged, thus disconnecting the electric motor/generator (51) from the turbo charger (12). The high dynamic pressure from the front nozzles (2)(3) is thus directly connected to the low dynamic pressure at the rear nozzles (6), allowing the aerodynamic drag power which are caused by the occurrence of these dynamic pressure differences, to be captured by the turbo charger (12).

The motor/generator (51) can be set into a generator or motor modes. In the motor mode, the turbo charger (12) will increase the effective mechanical power of the motor/generator (51) thus increasing mechanical power transferred to the wheels (23). In the generator mode, the turbo charger (12) will increase the effective electrical output power of the motor/generator (51) reducing the load on the internal combustion engine that may be used for charging in a hybrid configuration. These different combinations of power conversions should be optimised to the desired performance criteria.

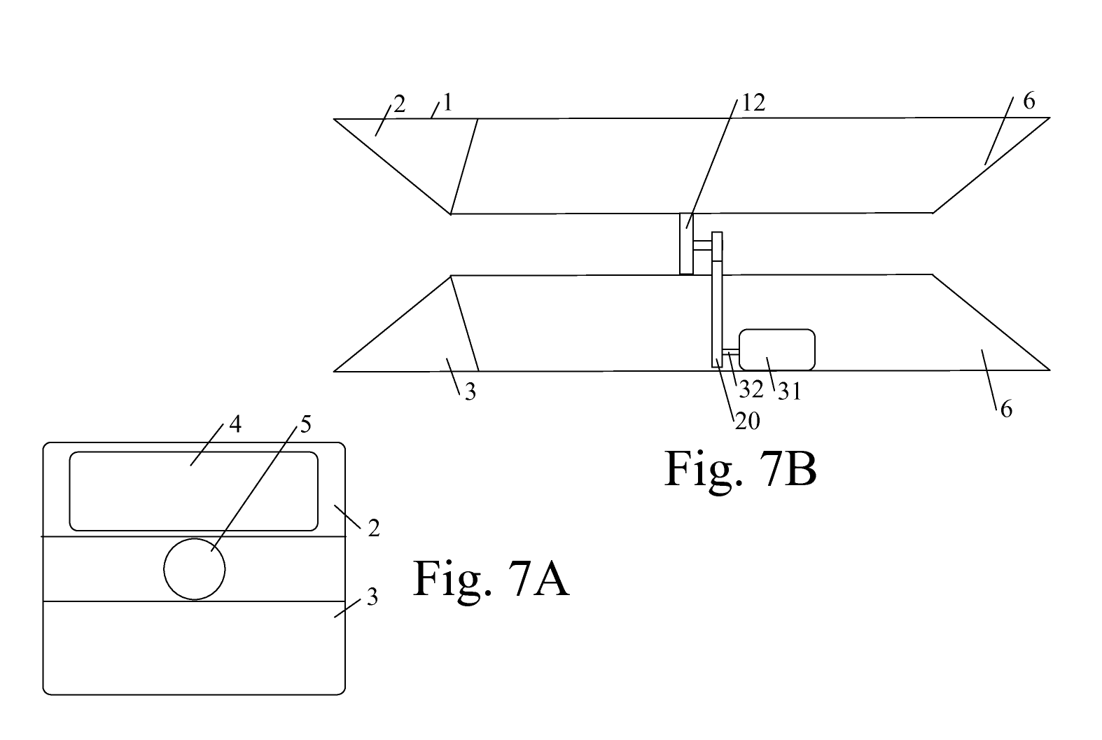

FIG. 7A-7B show an embodiment in environments where thermal engine and wheels are not suitable such as underwater. It is similar to the embodiment as explained in FIG. 6A-6B, except that the components used to drive the wheels; drive shaft (21), differential gear (22) and wheels (23) are removed.

Although the present invention has been described with reference to specific embodiments, also shown in the appended figures, it will be apparent for those skilled in the art that many variations and modifications can be done within the scope of the invention as described in the specification and defined in the following claims.

Accordingly, the scope of protection is not limited by the description set out above but is only limited by the claims, which follow that scope including all equivalents of the subject matter of the claims. Each and every claim is incorporated into the specification as an embodiment of the present invention. Thus, the claims are a further description and are an addition to the preferred embodiments of the present invention. The discussion of a reference in the Background of The Invention and Technical Problem is not an admission that it is prior art to the present invention, especially any reference that may have a publication date after the priority date of this application. The disclosures of all patents, patent applications and publications cited herein are hereby incorporated by reference, to the extent that they provide exemplary, procedural or other details supplementary to those set forth herein.

Alfa Romeo® is a registered trademark of FIAT GROUP MARKETING & CORPORATE COMMUNICATION S.P.A.Via Nizza, 250, Torino, Italy, 10126

MailOnline® is a registered trademark of Associated Newspapers Limited CORPORATION UNITED KINGDOM Northcliffe House 2 Deny Street, Kensington London ENGLAND W85TT.

### 9. DESCRIPTION OF THE REFERENCE NUMERALS USED IN THE ACCOMPANYING DRAWINGS ACCORDING TO THE PRESENT INVENTION

| Reference | |
|---|---|
| Numerals | Description |
| 1 | zero aerodynamic drag vehicle |
| 2 | upper air intake nozzle |
| 3 | lower intake nozzle |
| 4 | transparent viewing port |
| 5 | air intake |
| 6 | exhaust nozzle |
| 7 | vectored thrust vanes |
| 8 | fixed nozzle sidewall |
| 9 | moveable nozzle sidewall |
| 10 | air compressor |
| 11 | burner |
| 12 | turbo charger |
| 13 | compression pipe |
| 14 | compression pipe shaft |
| 15 | hot gas pipe |
| 16 | hot gas shaft |
| 17 | exhaust pipe |
| 18 | exhaust outlet |
| 19 | intake pipe |
| 20 | transmission |
| 21 | drive shaft |
| 22 | differential gear |
| 23 | wheel |
| 24 | alternate viewing port |
| 30 | internal combustion engine |
| 40 | standard compact car |
| 41 | air collector |
| 42 | exhaust diffuser |
| 43 | fins |
| 51 | electric motor/generator |
| 52 | motor shaft |

What is claimed is:

1. A vehicle for transporting passengers and or goods, comprising:
a plurality of air intake nozzles (2)(3),
a plurality of exhaust nozzles (6),
a plurality of air intakes (5),
a plurality of exhaust outlets (18),
a plurality of intake pipes (19),
a plurality of compression pipes (13),
a plurality of hot gas pipes (15),
a plurality of exhaust pipes (17),
a plurality of air compressors (10),
a plurality of burners (11),
a plurality of turbo chargers (12),
a plurality of compression pipe shafts (14),
a plurality of hot gas shafts (16) and
a plurality of viewing ports (4)(24).

2. The vehicle as of claim 1, in which a plurality of said nozzles (2)(3)(6) may have mechanisms such as overlapping fixed nozzle sidewalls (8) and moveable nozzle sidewalls (9) which allow the sizes and shapes of the nozzles to be changed so as to reduce the aerodynamic drag coefficient of the said vehicle.

3. The vehicle of claim 2, in which the said air compressor (10) and said turbo charger (12) use turbines and the propulsion is driven by the expulsion of the hot exhaust gases as in turbo jets or turbo fans.

4. The vehicle of claim 3, in which the rotational energy of the said shafts (14)(16) are transferred to wheels (23) using a plurality of transmissions (20), a plurality of differential gears (22) and a plurality of drive shafts (21).

5. The vehicle of claim 2, in which a plurality of said air compressors (10) use pistons and a plurality of pipes (19)(13)(15)(17), shafts (14)(16), burners (11) and optionally turbo chargers (12), are configured as internal combustion engines (30).

6. The vehicle of claim 1, in which a plurality of said air intake nozzles (2)(3) are configured as air collectors (41) placed at locations at the said vehicles (1) (40) with the highest dynamic pressure and a plurality of said exhaust nozzles (6) as exhaust diffusers (42) placed at locations with the lowest dynamic pressure.

7. The vehicle of claim 2, in which the said air compressor (10) and said burner (11) are replaced by a plurality of electric motor/generators (51) which are connected to a plurality of connections of turbo chargers (12), transmissions (20), motor shafts (52) and to a plurality of wheels (23) using a plurality of connections of differential gears (22) and drive shafts (21).

8. The vehicle of claim 7, in which the said drive shaft (21), said differential gear (22) and said wheel (23) are not required because the said vehicle (1) operates in environments where the said thermal engines and said wheels are not useable, such as but not limited to underwater.

9. A method of designing vehicles comprising steps of:
providing a plurality of intake nozzles (2)(3) of such sizes that they are large enough to cover the full frontal surface area of the vehicle (1); and
providing a plurality of exhaust nozzles (6) of such sizes that they are large enough to cover the full frontal surface area of the vehicle (1); and
providing a plurality of fixed nozzle sidewalls (8) and moveable nozzle sidewalls (9) for the nozzles in front (2)(3) as well as the rear nozzles (6) such that they can slide against each other so that the sizes of the nozzles can be changed; and
providing a plurality of viewing ports (4) (24) which allow good visibility to any driver even when the upper intake nozzle (2) is moved; and
providing a path for the air intake (5) to go to the exhaust outlet (18) through various types of thermal engines such as turbo jets, turbo fan jets, turbo props and internal combustion engines which may comprise of air compressors (10), burners (11), turbo chargers (12), pipes (19)(13)(15)(17) and shafts (14)(16) so that the aerodynamic drag power can be harnessed by the thermal engines; and
providing a path for the air intake (5) to go directly to the exhaust outlet (18) in the absence of any thermal engine; and
providing a path for the air intake (5) to go to the exhaust outlet (18) through a turbo charger (12) where the aerodynamic drag power can be harnessed to be transferred to a plurality of electric motor/generators (51) using a plurality of transmissions (20) and motor shafts (52); and
providing a plurality of air collectors (41) instead of air intake nozzles (2)(3) for typical aerodynamically designed cars such as a compact car (40) at the place with high dynamic pressure which is the flat and vertical front most portion of the compact car (40); and
providing a plurality of exhaust diffusers (42) instead of exhaust nozzles (6) for typical aerodynamically designed cars such as a compact car (40) at the place with low dynamic pressure which is the flat and vertical portion at the back most part of the compact car (40).
